(19) United States
(12) Patent Application Publication
(10) Pub. No.: US 2017/0262813 A1
(43) Pub. Date: Sep. 14, 2017

(54) SYSTEM AND METHOD FOR TRACKING AND OPTIMIZING LEAVE FOR EMPLOYEES

(71) Applicant: LeaveLogic, Inc., Seattle, WA (US)

(72) Inventors: Anna Steffeney, Seattle, WA (US); Justin Alford, Washington, DC (US)

(21) Appl. No.: 15/454,850

(22) Filed: Mar. 9, 2017

Related U.S. Application Data
(60) Provisional application No. 62/305,904, filed on Mar. 9, 2016.

(51) Int. Cl. G06Q 10/10; G06Q 30/00

(52) U.S. Cl. CPC G06Q 10/1057; G06Q 30/018

(57) ABSTRACT

A computer-based system executing a computer-based method for facilitating an employer's relationship with its employees with regard to the vast array of laws and regulations concerning employee leave. Employers and employees may have a difficult time navigating though the laws and regulations of the employer/employee relationship as each employee is afforded leave benefits. Leave benefits may include paid holidays, paid vacation, full and partial paid time-off, unpaid time off with fear of losing a job and other time-off scenarios where an employee may wish to or need to be away from normal work duties for some amount of time. The service and system provides a way to inform employees about leave benefits, to track employee's use of and engagement with leave benefits, and to ensure compliance with laws and regulations of leave benefits across various jurisdictions.

### CROSS REFERENCE TO RELATED APPLICATION

[1] The present application claims priority and benefit from the U.S. Provisional Patent Application No. 62/305,904, filed Mar. 9, 2016 and titled, “SYSTEM AND METHOD FOR TRACKING AND OPTIMIZING LEAVE FOR EMPLOYEES”. The entire content of the provisional application is herein expressly incorporated by reference.

### BACKGROUND

Companies and organizations are subject to a great number laws and requirements when it comes to employing people. One subset of these laws involve how these companies and organizations must treat leave time requested and used by these employees. That is, several labor laws, like the Family and Medical Leave Act (FMLA), require employers to provide work policies that allow employees to take leave from work duties due to various life events, such as birth of a child or a serious illness for an employee or an employee's immediate family member. The laws governing a particular company may simultaneously envelop federal, state, and local laws.

As a result of so many laws affecting various companies and organizations in different jurisdictions, both employers and employees may be left confused with the vast array of interleaved laws and regulations. Further, employees may be unaware of legal rights during a life event and employers may not comply with such laws in terms of providing information and awareness to employees during employment. Beyond even making employers and employees aware of the laws and regulations, keeping track of how an employee uses leave also becomes more and more difficult as more and more laws and regulations are created or changed.

In short, laws and regulations in the area of the employee/employer relationship are ripe with pitfalls and traps from both the perspective of the employer and the perspective of the employee.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a service for tracking and optimizing employee leave information within an organization according to an embodiment of the subject matter disclosed herein;

FIG. 2 is a computing system executing tasks within a service for tracking and optimizing employee leave information according to an embodiment of the subject matter disclosed herein;

FIGS. 3A-3F are a series of screen shots of a service for tracking and optimizing employee leave information according to an embodiment of the subject matter disclosed herein;

FIG. 4 is a flow chart of a method for tracking and optimizing employee leave information according to an embodiment of the subject matter disclosed herein; and

FIG. 5 is a diagram illustrating elements or components that may be present in a computer device or system configured to implement a method, process, function, or operation in accordance with an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

By way of overview, the subject matter disclosed herein may be directed to systems, apparatuses, and methods for providing a computer-based system executing a computer-based method for facilitating an employer's relationship with its employees with regard to the vast array of laws and regulations concerning employee leave. As discussed briefly in the background section, both employers and employees may have a difficult time navigating though the laws and regulations of the employer/employee relationship as each employee is afforded leave benefits. Leave benefits may include paid holidays, paid vacation, full and partial paid time-off, unpaid time off with fear of losing a job and other time-off scenarios where an employee may wish to or need to be away from normal work duties for some amount of time. Various laws that have been enacted on federal, state, and local municipality levels (such as the FMLA, and CFRA) require employers to provide for employees to take away from work duties for a specified amount of time without losing his/her job. In various embodiments as discussed herein the leave benefits service provides a way to inform employees about leave benefits, to track employee's use of and engagement with leave benefits, and to ensure compliance with laws and regulations of leave benefits across various jurisdictions.

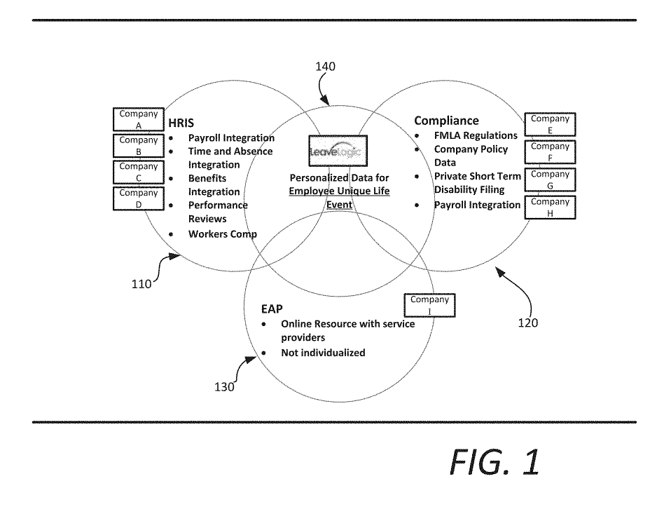

Such a service is particularly beneficial as sometimes employees do not understand how to navigate their leave benefits and often query multiple sources, including outside the company. This may result in the employee ultimately feeling under supported and undervalued as well as potentially being provided incorrect of conflicting information. Further, a leave benefits service may streamline the coordination of leave benefits planning and tracking for both employees and employers. Further yet, a leave benefits service alleviates administration time used to inform employees and to track leave benefits use for various human resource employees and managers. Having a leave benefits service also assists with management as managers are better prepared to know what retention options are available when discussing leave with employees. These and other advantages will become more apparent in the detailed descriptions below with respect to FIGS. 1-5.

FIG. 1 is a diagram of a service for tracking and optimizing employee leave information within an organization according to an embodiment of the subject matter disclosed herein. This diagram is intended to provide a top-level, organization view of a typical company or organization. A typical company may have several different departments or sub-organizations that handle various aspects of an employer-employee relationship. Further, the company may commonly use several different systems for tracking and maintaining these employer-employee relationships. In this diagram, three such systems may include human resource information system (HRIS) 110, a legal compliance system 120, and an employee assistance program (EAP) 130.

The HRIS 110 may handle aspects of the employer-employee relationship that include payroll integration, time and absence integration, benefits integration, employee performance reviews, and workers' compensation. However, a typical HRIS system 110 is wholly unaware of any non-occupational legal compliance issues and does not provide any employee assistance programs. In turn, the legal compliance system 120 may provide a company with Federal, State, and local municipality regulations, company policies, short-term payroll disability coordination and payroll integration with respect to the legally required leave benefits. However, the legal compliance system may not be able to effectively track leave benefits that is better suited within the HRIS system 110 or provide EAP aspects. Lastly, an EAP system 130 may provide information to employees as a whole that is not individualized and often provides such information in disparate ways, such as the day that an employee is hired (and then never again) or through rudimentary online ways that remain confusing and difficult. Further, conventional EAP systems do not integrate with HRIS 110 or legal compliance 120 systems.

The leave benefits service 140 provides a liaison between these three disparate systems 110, 120, and 130 and the individual circumstances of an employee. As discussed in greater detail below, the leave benefits service 140 provides a system by which data from HRIS for individual employees can be tracked and provided alongside personalized employee assistance program information and can be done so in a way that complies with the legal compliance system form a company. The leave benefits service coordinates data and rules from these and other systems so as to provide each employee with an individualized array of leave benefits options in a timely manner than can be easily tracked and recorded. Further, employees may have the the additional ability to “model” their leave by providing different scenarios and “what-if” analysis (e.g., what if my due date is earlier, what if I am disabled longer).

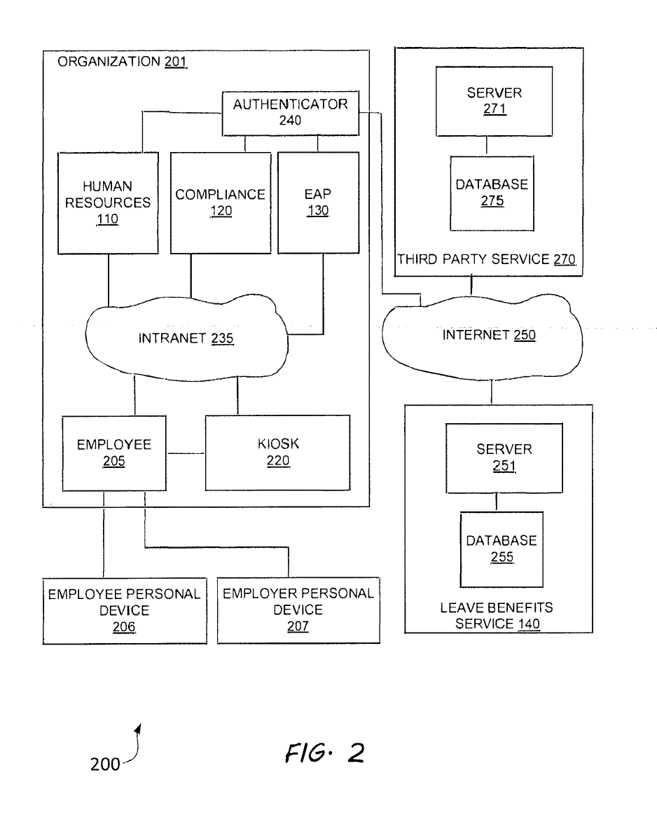

FIG. 2 is a computing system 200 executing tasks within a service for tracking and optimizing employee leave information according to an embodiment of the subject matter disclosed herein. The system 200 may include computing systems associated with the organization 201, the leave benefits service 140 and a third-party service, such as payroll handling and the like. An employee 205 (as represented by a computing device 205) may interact with various entities within an organization through an intranet 235 or may interact with various external computing entities through the Internet 250. Further, an employee may also interact with these various computing entities using a company-provided kiosk 220, an employee personal device 206 (e.g., a smart phone) or an employer-personal device 207.

The various interactions between these different computing entities may be protected via authentication services at various gateways and portals. Once such service is authenticator 240 that always checks credentials prior to allowing access to sensitive data that may be part of the HRIS 110, compliance 120 and EAP 130 systems. The leave benefits system may provide coordination between an organization's computer systems (i.e., HRIS 110, etc.) and the employee when the employee acts through one or more computing devices (employee computer 205, personal device 207, etc.). The leave benefits service 140 may be executing in a cloud-based computing environment and have at least one server computer 251 hosting at least one database 255. Likewise, one or more third-party services 270 may be executing in a cloud-based computing environment and have at least one server computer 271 hosting at least one database 275. With such a system, several computer-based methods and solutions may be implemented to provide leave benefits tracking and optimization.

A first benefit to be realized is the automated submission of a plan to take advantage of leave benefits. An employee may use the leave benefits service to plan leave. The service provides forms for filling out and for signature. Then the service 140 may automatically submit the forms to appropriate personal and inform appropriate systems in an organization. This may then automate payment systems for leave benefits, such as reduced pay or suspension of pay and the like.

Another beneficial method is the automated compliance with laws and regulations. Once an employee submits leave benefits forms though an automated service, various record can be updated so as to assure compliance with laws and regulations. For example, when an employee is first hired, specific automated checkboxes may be used for the employee to affirm that the leave benefits have been presented and explained. This may be triggered by other events as well such as an employee simply considering leave. Further, an employee may affirmatively indicate that information about changes in laws and regulations have been received and reviewed.

Another beneficial method includes determining various risk factors for an employer when various leave benefits are invoked. Thus, as an employee may choose to take one week leave to deal with an ill child, various risk factors associated with probabilities of return to work or invocation of the leave benefit again with a specific time period may be presented to an employer. These statistics may be complied from nationalized or globalized data from empirical evidence. Further, flight mitigation tools may be provided to managers for alleviating flight risk or to make proactive plans based on flight risk, such as allocation of human resources and capital.

Another beneficial method may include multi-jurisdiction compliance, coordination, and policy smoothing. As various organizations may be operating across several different state, federal and international jurisdictions, a company may be provided with assistance in tailoring a company-wide set of leave benefits that comply with all jurisdictions, yet maximize productivity in all areas or in key areas.

Another beneficial method may include providing the leave benefits service through software-as-a-service (SaaS) interfaces. These interfaces may be tailored for use on smart phones, smart devices, or dedicated kiosks. In this manner, an employee may review and plan from any connected device and browse plans and possibilities at any time.

Another beneficial method may include coordination of notifications and just-in-time training. As life events occur, an employer may be notified of such life events of an employee and may be asked to explain the current state of leave benefits. The system may coordinate automated notifications to both employees and to managers of employees such that each may be informed of leave benefits. Further, the managers may be informed of additional aspects of the leave benefit such as prohibitions on communications during leave. Further, the system may track and store affirmations of receipt of these notifications to provide liability-shifting records for legal compliance. Such data may be stored with employee records and training records.

Another beneficial method may be the provision of interaction, automation and linking between the leave benefits service and other third-party services such as insurance companies and the like. Thus, as an employee chooses to enact a plan for leave, a short-term disability insurance company may be able to be linked such that automated information is exchanged information the insurance company of the invoking of a plan benefit tied to a leave choice. Additional coordination may be realized by automatically enrolling a newborn into an insurance program complete with an exchange of government related data and medical records. Further yet, from the employer perspective, automated methods may submit necessary forms to government or state agencies for the purposes of compliance or reimbursement.

Another beneficial method may be the generation of a workplace score with respect to leave benefits. As some choices for leave benefits are not always mandated by laws and regulations, some companies or organizations may choose to implement leave benefits and leave policies that are better than others. The leave benefits service may be used to assimilate all information across participating companies and generate a relative score based on other companies' leave benefits. The benefits score may be normalized against a minimum requirements score or may be normalized against an average of participating companies.

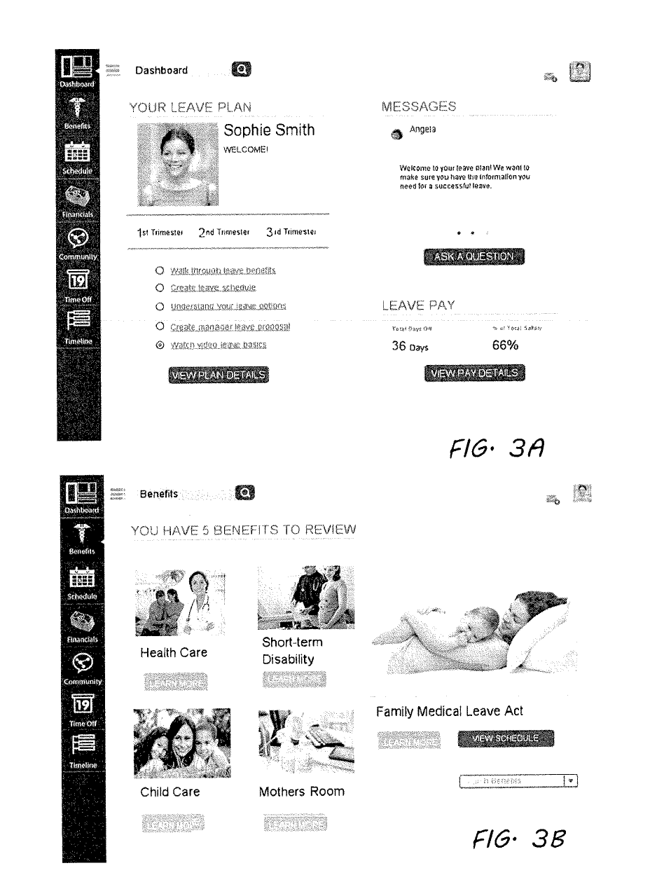

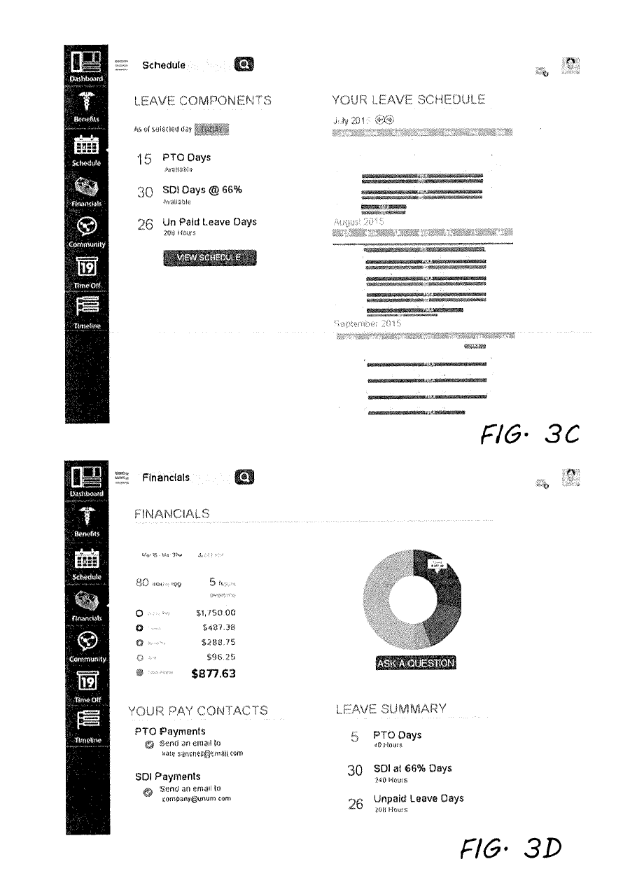

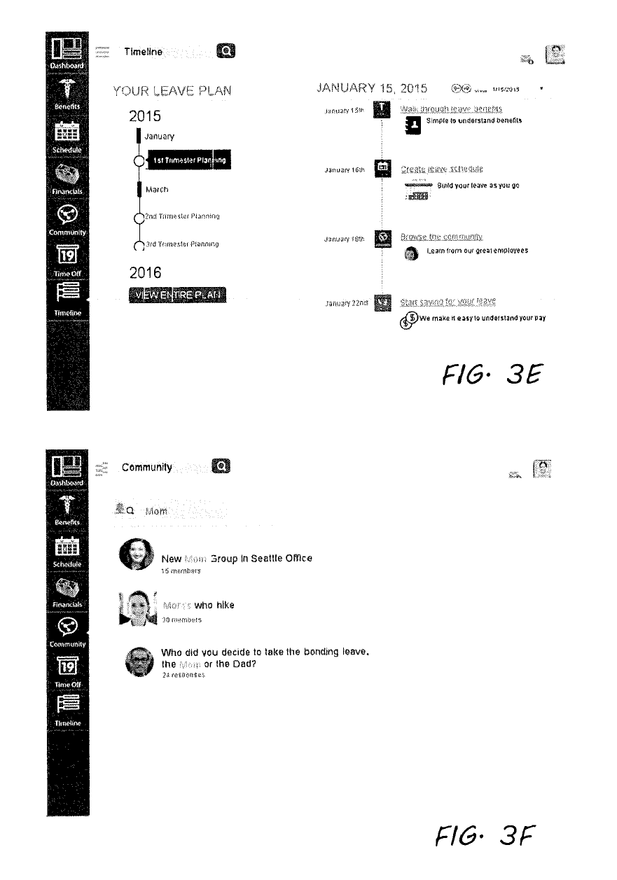

FIGS. 3A-3F are a series of screen shots of a service for tracking and optimizing employee leave information according to various embodiments of the subject matter disclosed herein. The screen shots show various ways that employees may interact with the leave benefits service 140. These screen shots are intended to provide an example view of one possible embodiment of various user interfaces for an employee when using the leave benefits service 140. Other user interfaces are contemplated but not shown here for brevity. Further, a set a screen shots and user interfaces may also be designed for use by an employer as well.

FIG. 3A shows a screen shot of a dashboard view of leave benefits service 140. This may be an initial view in which an employee is presented when the employee uses a computing device to browse to a web page or web service via a web browser application or other dedicated application. The dashboard may show personalized and individualized information such as personal messages and a picture of the employee. Additional statistics most relevant to the employee may also be displayed such as vacation days available, sick days available, and leave time remaining. From the initial dashboard screen, the employee may then also navigate to several other web-based pages or displays that are generally shown in a menu bar along the left side of the screen. This menu generally corresponds to FIGS. 3A-3F.

FIG. 3B shows a personalized dynamic benefits page having specific leave benefits that are suited to the employee location, type, and life event selection. In this example, the leave benefits shown include health care options, short-term disability options, childcare options and mother's room information. Further, the employee may navigate to additional information such as a schedule associated with legally required benefits via the FLMA. A search of leave benefits may also be available from this page or other pages.

FIG. 3C shows a screen shot for a calendar showing a schedule of benefits associated with the employee. This calendar may show various time frames and windows for leave benefits for the employee. The calendar may show planned leave as well as possible leave times. Further, an employee's spouse may also be shown in terms of planes leave and available leave for coordination of planning for a family. Further yet, the employee may explore different what if scenarios so as to analyze effects of various choices for leave.

The leave benefits service may provide the employer with additional tools to be used to compare options from an individualized and personal perspective. Once such tool may be a slider control that the employer may maneuver to compare time off against financial compensation. Thus, the slider may be linked to several different factors in leave benefits choices such that at one end of the slider, the time off factor is maximized whereas at the other end of the slider, the financial compensation factor is maximized. This may allow an employer to plan a set of leave benefits based upon an overall goal of at least a specific amount of financial compensation or specified amount of time off.

FIG. 3D shows a screen shot for financial considerations based upon various leave benefits associated with the employee. Here an employee may be presented with financial ramifications of various leave choices. The employer may choose to consider using one form of leave (vacation) against another form of leave (paid time off) or combinations thereof. An example paycheck may be shown as well as a schedule of receivables before during and after planned leave. The financial calculations for these presentations may be automated based on integration with the payroll data, policies from the employer as well as have reflected the various interactions of local, state, federal, and international laws and regulations.

FIG. 3E shows a screen shot for a timeline items view having a schedule of benefits associated with the employee. The timeline view may show next dates for a shift in one or more leave benefits. The timeline items view shows one or more just-in-time actions and information an employee may wish to know and need to follow related to their specific leave scenario and related benefits determined by the leave benefits service. These timeline items can be viewed, marked completed, and filtered by intervals that are specific to their leave scenario (e.g., 1st, 2nd, and 3rd Trimesters for maternity leave).

FIG. 3F shows a screen shot for a community of similarly-situated people using various leave benefits that are also associated with the employee. In this manner, an employee may be able to see comments and suggestions posted by other people or may choose to interact in an online manner with other people. In this manner, the leave benefits service may be used to coordinate organization of mutual support groups, such as expectant mothers or grieving individuals.

These various services concerning leave benefits may also include just-in-time notifications to employees regarding upcoming events in their leave Scenario and just-in-time manager training for managers when their employees indicated they are taking leave (this relates to the company compliance where companies need to ensure their managers are acting in accordance to regulations and company policies). This may be implemented by providing notifications to managers tailored to the type and duration of leave their employee(s) have indicated they will take.

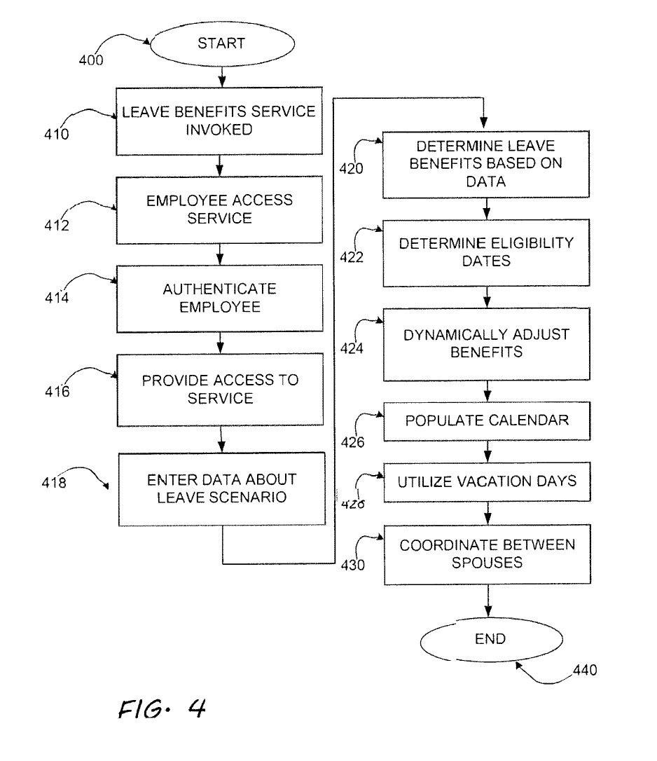

FIG. 4 is a flow chart of a method for tracking and optimizing employee leave information according to an embodiment of the subject matter disclosed herein. In this method, an employee may invoke various steps as shown to coordinate and plan leave benefits. Additional steps may be implemented that utilize additional information such as turf analysis or may discount some data because of anomalies. Further, the steps of the method in FIG. 4 may be implemented in any order and not necessarily the order presented in the embodiment of FIG. 4. Generally, the steps of the method in FIG. 4 correspond to an employee experience when using the leave benefits service as depicted in screen shots of FIGS. 3A-3F.

The steps of the method allow a user to invoke the service at step 410 and then navigate to various service offerings at step 412. The employee may need to be authenticated at step 414 in order to gain access to confidential information about the employee or the employer. Once authenticated, the employee may access the service at step 416 and then select a particular leave scenario to explore or to invoke at step 418. At step 420, the leave benefits service may determine leave benefits based on available data at step 420. From the available data or from newly entered data, the service may determine eligibility dates at step 422, dynamically adjust the benefits as the employer shifts parameters at step 424, populate an employee calendar at step 426, utilize vacation days at step 428, and/or coordinate benefits between spouses at step 430.

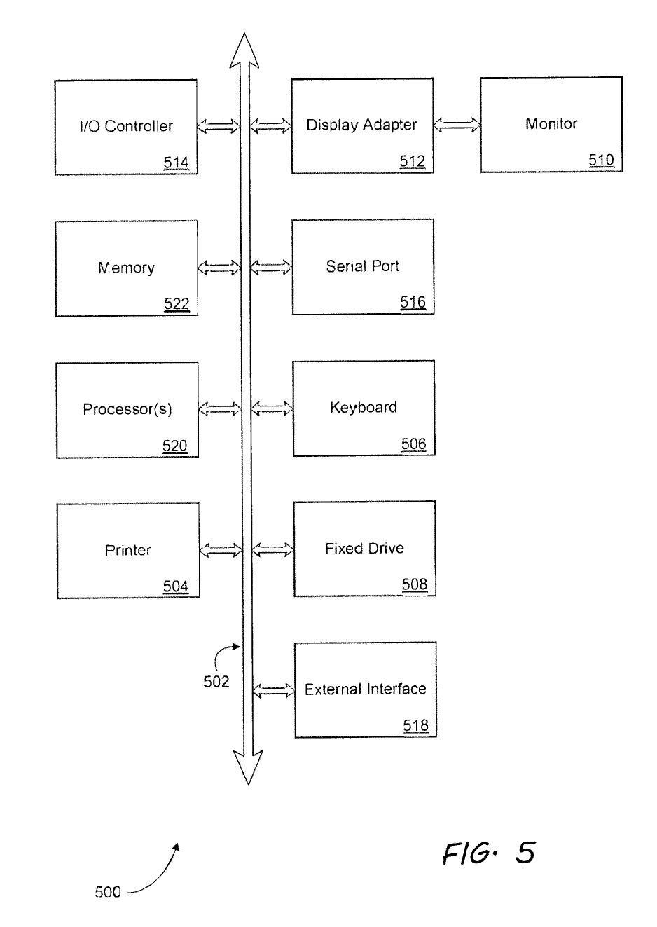

FIG. 5 is a diagram illustrating various computing elements or components that may be present in a computer device or system 500 configured to implement various computer methods, processes, functions, or operations as discussed above in accordance with various embodiments. The various subsystems shown in FIG. 5 are interconnected via a system bus 502. Additional subsystems may include a printer 504, a keyboard 506, a fixed drive 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5 including a wide area network such as the Internet, a mouse input device, and the like. The interconnection via the system bus 502 allows one or more processors 520 to communicate with each subsystem and to control the execution of instructions that may be stored in a system memory 522 and/or the fixed drive 508, as well as the exchange of information between subsystems. The system memory 522 and/or the fixed drive 508 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A computer-implemented method, comprising
receiving input from a remote user, the input corresponding to employment information about the user;
determining a set of benefits offered by a company providing employment to the remote user;
assessing the information received from the user to determine a set of benefits available to the remote user in response to the determined set of benefits offered by the company;
determining an optimal set of benefits available to the remote user in response to the assessment of the received information;
providing a user interface to the remote user for selection of one or more sets of benefits determined to be available; and
receiving a choice from remote user corresponding to at least one of the sets of benefits.
